(19) United States
(12) Patent Application Publication
(10) Pub. No.: US 2015/0356512 A1
(43) Pub. Date: Dec. 10, 2015

(54) System and Method for Optimizing Job Candidate Referrals and Hiring

(71) Applicant: Steve Bradley, Denver, CO (US)

(72) Inventor: Steve Bradley, Denver, CO (US)

(21) Appl. No.: 14/736,181

(22) Filed: Jun. 10, 2015

Related U.S. Application Data
(60) Provisional application No. 62/010,055, filed on Jun. 10, 2014.

(51) Int. Cl. G06Q 10/10; G06F 17/30

(52) U.S. Cl. CPC G06Q 10/1053; G06F 17/30867; G06F 17/30828

(57) ABSTRACT

A comprehensive method and system is disclosed for registering candidates, retrieving a self-assessment of their own skills and experiences, validating one or more of their skills and experiences leveraging third party websites and/or former managers or colleagues, associating those skills with focused and relevant video clips that permits immediate assessment of honesty and interpersonal communication skills in key areas of need, side by side comparisons between multiple candidates simultaneously and a simple “one button” click to arrange an interview or provide feedback to a candidate.

### PRIORITY CLAIM

This application claims priority from a provisional application filed on Jun. 10, 2014, having application Ser. No. 62/010,055.

### BACKGROUND OF THE INVENTION

The current approach to hiring candidates is flawed and inefficient. In spite of the fact that there are now a plethora of online “job boards”, the proliferations of these services has resulted in candidates often taking a “scattershot” approach to applying by simply submitting applications for jobs for which they are not qualified, such as lacking the relevant expertise, requiring salary or compensation that is significantly more than the employer wants to pay, or lack critical social or personal skills that would be desirable.

An example of this common issue is present on Monster.com® or even social networking sites like LinkedIn®. In both cases, candidates are asked to add their list of skills but there is little to no validation about whether they indeed have those skills, how they present themselves or whether they are the kinds of people that would fit into the culture of a prospective employer. Even tools like “endorsements” on LinkedIn provide only an indication of whether a person who they are linked to happens to like the profile. In many cases, the endorsement is based on little more than friendship or familiarity rather than direct experience. This makes sifting through hundred if not thousands of seemingly “qualified” candidates difficult and time-consuming.

Similarly, the current state of the art among job boards is often impossible to decipher for candidates. When a candidate posts a resume, it is often difficult to know how much interest that employers might have, what skills that they were looking for that may not be listed on your profile but may be relevant to one or more positions, and whether the profile you have posted in being received by prospective employers.

In sum, the current systems for finding, posting, interviewing and hiring candidates is inefficient, time-consuming, impersonal, provides little in the way of reliability or honesty regarding skills and little or no feedback to the candidates. What is needed, then, is a system that can help provide a “skills based” approach to online hiring that focuses candidates on what skills they have, provides a means for ranking and validating those skills that relies on more than simply self-reporting, enables a better way to get a personal feel for the candidate outside of an “online resume” and a means for giving more effective feedback to candidates so that they understand how to better optimize their profiles with their most important skills and to present themselves in a manner that would help qualified candidates and prospective employers more likely to achieve positive results.

### SUMMARY OF THE INVENTION

The system and method of the present invention provides a solution to many of these difficulties by providing a process and method for posting, validating and enabling the search of relevant profiles in a unique manner. More specifically, the system includes the following components: a website or other front end interface for permitting registration and skills identification based on a database of common skills and attributes, a connection program for connecting one or more social or professional websites that can be used to provide or validate information about the candidate's skills and attributes, a video creation software program for creating and/or uploading one or more videos in which the candidate either uploads a video or responds to one or more questions or scripts generated by the video creation software, a search engine for permitting prospective employers to search for one or more potential candidates, an video analytics program for analyzing one or more features of the posted video to ascertain one or more attributes about the candidate or their skills, a video extraction tool that interprets and store the words used in the video and can set one or more “playback” points based on the presence of those key words, and a communications engine for enabling communications and feedback between a recruiter and the candidate and permitting the arrangement of follow-up interviews and other related communications.

In the preferred embodiment, the process begins when a candidate registers on the system using the front-end interface. This could include the basic style of registration—such as form fields on a web page—or may also include tools for retrieving or extracting information using one or more files that are either provided by the candidate (such as a text or PDF of a resume) or are retrieved from an online service such as LinkedIn. In the preferred embodiment, whether selected by the candidate manually, extracted from a file or retrieved via an API call to another website or social platform, the received input about the candidate would be modified or updated to correspond to a database on commonly used or requested skills. This could be done either by only limiting entry of skills or attributes to those that are stored in a pre-existing skills database via the website or by matching one or more of the key words used in the profile or uploaded documents to “match” the similar terms used by the candidate with one or more skills or attributes listed in the skills database.

There are a number of known heuristically developed models and algorithms for achieving this outcome that can be applied to the present invention such as key word matching (using either one or a cluster of words), by using the primary field or expertise of the candidate (since many different fields may use similar words for very different purposes—a biologist that helps find “bugs” for example, is not at all the same when a programmer specializes in finding “bugs”) or by presenting a list of “related” skills or attributes and confirming with the candidate that the retrieved list of attributes or skills is an accurate replacement for the skills or attributes originally entered. Use of this process helps create consistency in the collected data that enables easier search, identification and relevance for the recruiters.

Once these skills have been collected and entered, the system preferably includes a series of sliders that permit a candidate (or through analysis of the data entered, the system) to provide a strength (such as a numerical ranking) with each skill along with an indication of the years of experience they have performing or optimizing this skill. This is particularly important in cases where an employer may not just want to know that you have “10 years of work experience” but rather 10 years working on a specific skill or expertise. This is once again a reflection of the “skills centered” approach of the present invention. Thus, a person that has been a software developer for 15 years but may only have 2 years experience with Ruby on Rails, for example, would permit a recruiter to find a more qualified candidate that may have only worked as a developer for 5 years but all of those years have been working with Ruby on Rails.

These self-reported skills can be further modified or validated using input from third party sources such as colleagues, former managers, companies with whom they have worked or groups in which they have been engaged in substantive discussions relating to their skills or in which they have established a reputation in one or more skills or fields such as Quora®, Twitter® lists, Klout®, or StackOverflow.com. This information could either be extracted via API by the system or could trigger an electronic request, such as an email with a special link, requesting that the relevant person, manager, colleague or other reliable source enter or confirm information submitted by the candidate regarding their skills and experiences.

The present invention also includes video software that could permit creation and/or upload capabilities that would permit a candidate to describe their expertise and work experiences. The video capture process could be based on a “free form” video (i.e. the candidate spending 5-10 minutes discussing their career, job experiences and sample work), could be based on a series of questions that could be provided by the system to enable a candidate to discuss specific skills or work experiences that they have listed on their profile—particularly those for which they have indicated strong or deep experiences—or could be created using an automated script generated by the system that is selected based on information that was submitted about the candidate such as their particular field of expertise. The latter is particularly useful when recruiters in a given field of expertise have indicated that addressing certain skills or attributes is important for their evaluation. These videos could be created using a computer video camera, done in a professional studio or other means of video capture. Furthermore, while the video may be posted or created in a single sitting, it could also be posted or created in smaller recordings and later concatenated by the video software.

As noted above, the video software also includes one or more script or question generation routines that can provide a candidate with an outline of the areas that should be addressed or questions that they may wish to answer. For example, if the candidate were to have self-reported a high skill value in leadership, the video software could prompt the candidate to “Describe your leadership skills” when creating the video or could also present a “prepared script” for the candidate to use during video creation that highlights leadership as an area that they should address. This could optionally also be accompanied by recommendation on how long the segment should be or other coaching directions that can help improve the quality and impact of the video. The system could also work in reverse—if a skill is discussed in the video that is not listed on the candidate's profile, the system could prompt the candidate to include that skill in their skills and attributes profile.

Once the video has been created and/or uploaded, the present invention can use video analysis software to extract words spoken within a video. The words can then be stored alongside the video and indexed by the video analysis software to enable certain “playback points”—points that identify the location of keywords that are associated with one or more relevant skills or attributes. These key words and index information can then be used by a search engine to help permit video playback by one or more recruiters that is expressly focused on skills that are needed for a job. Once a recruiter inputs or otherwise searches on one or more these key words, the system would search the “script” created by analyzing the video to identify the portions of the video that would be of greatest interest to the recruiter and would permit playback of those relevant portions of the video thereby significantly reducing time spent watching video that is either of less relevance or less critical. Given that there may be many potential candidates, by indexing the video and permitting playback in this manner, the present invention significantly reduces the time and effort needed to filter down to a smaller pool of candidates.

For example, if the recruiter were to move a bar labeled “Years Experience” to represent 7-8 years for a particular skill, the system of the present invention could search for the words “7-8 years experience” in relation to that skill in the associated scripts extracted from the uploaded candidate videos. In this example, the search engine may also be programmed to return words indicating a reference to any experience “greater than 7 years”. Another example would be if the user interface represented 2 sliders, one for “Years Experience” and a second for “Leadership Skills”. If the recruiter moved the Years Experience bar to 7-8 and the Leadership Skills bar to 4-5, the search engine could then search any video scripts to search for any references to either “Leadership Skills=4 or 5” or search for any videos in which relevant candidates reference “Leadership Skills>4”. This would result in finding any videos in which a candidate has mentioned or discussed having more than 7 years of leadership experience and would deliver those portions of the videos that discussed leadership for display to the recruiter in response to the search. It is possible for an unlimited number of potential search optimizations and may include other variants such as mapping words like “many years” when spoken in a video as a hit when a recruiter is searching for candidates that have 3+ years of experience.

The video analytics software of the present invention would also optimally include use of available “emotional sensing” technology to interpret the voice and body language of the candidate in the video. For example, software that is current available for analysis of video is able to sense the tone and frequency of the voice using algorithms that can analyze various meanings that may be represented by the tone, level, frequency or other attributes. Analyzing the video in this manner allows the viewer—such as a recruiter—to receive input regarding characteristics that would otherwise not be available.

One such characteristic is truthfulness. Current voice technology (such as Layered Voice Technology offered by Nemesysco Ltd) can be applied during video creation or upload to ascertain, with a high degree of probability, if a speaker is telling the truth when discussing their skills or attributes. It is also possible, with various degrees of accuracy, to determine the level of truth. For example, if a speaker, during the video recording, expresses their Leadership Skill Level as 10 but the application of voice and/or body language video analytics programs suggests that the candidate exhibited characteristics associated with lying, that skill or candidate could be flagged as indicating that the candidate may not be 100% confident their Leadership Skills being a 10 or suggest that the candidate is exaggerating their skills and experiences.

As noted above, this same video analytics programs can also be used to interpret physical movements that may undermine the predicted accuracy or hidden intentions of the speaker as recorded on the video created or uploaded using the present invention. Common physical cues, such as eyes shifting to the side or shifting in the seat or other variants, can also be ascertained to assess whether the speaker is comfortable, honest and/or confident about their reported skills and attributes.

The results of this analysis could be applied as a simple flag (i.e. flagged as potential concern) or could be used to create a confidence interval or probability curve associated with the “predicted truth” of the stated skills. This could be the basis of a follow-up questions that the recruiter could discuss with the candidate or could also trigger further third party verification—such as requiring the candidate to submit further supporting information with respect to skills or experiences that were analyzed as meeting a lower probability of “truth”. In all cases, the information generated from the video analysis could be provided information in conjunction with the video when it is located during a search by a recruiter, could be used to filter that result from recruiters until further verification is complete, could lower their rank in any future searches on the skills that were flagged for veracity or could lower an evaluation score that is stored in the candidate's profile. Finally, while this analysis is described as being performed exclusively by a computer algorithm, for cases in which a candidate objects to the analysis or where the algorithm appears to suggests a strong probability of a mistruth, a second analysis could be performed by an alternative software algorithm or a human psychology expert who can validate one or more of the findings.

### BRIEF DESCRIPTION OF THE DRAWINGS

FIG. 1 shows a block diagram illustrating one or more components of one sample embodiment of the system of the present invention.

FIG. 2 illustrates a sample embodiment of the search engine 215 as displayed to the recruiter via the recruiter FEI 110.

FIG. 3 illustrates a sample embodiment of the candidate search results page as presented via the FEI 110.

FIG. 4 illustrates a sample embodiment of the candidate comparison functionality as displayed through the FEI 110.

FIG. 5 illustrates a sample embodiment a candidate profile screen as illustrated via the FEI 110.

### DETAILED DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s).

Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

A description of an embodiment with several components in concert with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step).

Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described such as a server, it will be readily apparent that more than one server or a cloud that leverages multiple servers may be used in place of a single device/article. Similarly, where more than one device or software program is described (whether or not they cooperate), it will be readily apparent that a single device or an integrated software program that includes multiple algorithms or capabilities may be used.

The functionality and/or the features of a device may be alternatively embodied by one or more other devices that are not explicitly described as having such functionality/features. Thus, other embodiments of one or more of the invention(s) need not include the device itself.

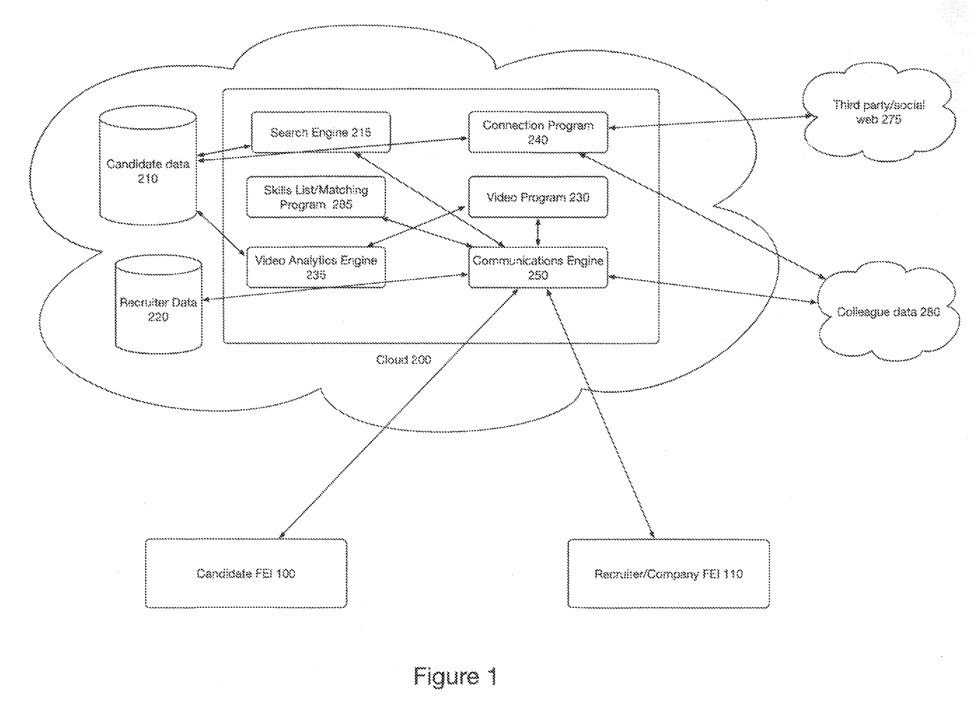

Referring now to FIG. 1, a block diagram illustrating one or more components of one sample embodiment of the system is shown. The components of the system are each described below. The first component is a website or other prospect front end interface 100 for permitting registration by a candidate using a computer, kiosk, mobile phone or other device that can display the front end interface and includes means for receiving input and display. The front-end interface 100 would communicate with a skills and attributes database 285 which would include a common skills and attributes. These skills and attributes may organized in the database 285 in a single list or may be organized and listed in accordance with one or more fields of expertise (i.e. Nurses would see a different list of skills from a software developer).

The system further includes a connection tool 240 for connecting the system to one or more social or professional websites that can be used to provide or validate information about the candidate's skills and attributes. The connection program 240 could use one or more application programming interfaces (APIs) that are stored within the connection program to extract the data from third party websites 275 that may have information relevant to the candidate. These third party sites 275 could be selected by the candidate or located by the connection program using search or other tools to locate information about the candidate that may be available on the Internet. Ideally, these sites would include ones that the candidate has established a reputation in one or more skills or fields such as reputations on services such as Quora®, Twitter® lists, Klout®, or StackOverflow.com. In each case, information submitted by the candidate (including videos as described below), retrieved via API, along with verification data described below are all stored in the candidate profile database 210.

The connection program 240 can further initiate communications to individuals such as colleagues, former managers, companies with whom they have worked, to request verification regarding the candidate's skills, attributes or experiences. This could be performed by the program 240 triggering an electronic request, such as an email with a special link, requesting that the relevant person, manager, colleague or other reliable source enter or confirm information submitted by the candidate regarding their skills and experiences. Information collected from third party sites 275 and verification data 280 from former colleagues can be stored in the candidate profile database 210 and either added to the profile itself or used to help adjust a confidence score associated with the skills and experiences that is stored in the candidate profile database 210. In one embodiment, the confidence score associated with the skills or attributes may also impact the rendering of the skills to recruiters. For example, the results displayed to a recruiter via the recruiter front end interface 110 could display a candidate profile using green text to display skills that appear to be strongly verified, yellow for skills that are not verified or only partially verified, and red to display skills or experiences that have information that appears to conflict with the candidate's self-reported skills assessment.

The system further includes video management software 230 for creating and/or uploading one or more videos in which the candidate describes their experiences and skills. The video capture process could be based on a “free form” video (i.e. the candidate spending 5-10 minutes discussing their career, job experiences and sample work), could be based on a series of questions that are provided by the software 230 to enable a candidate to discuss specific skills or work experiences that they have listed on their profile—particularly those for which they have indicated strong or deep experiences—or could be created by reading an automated script generated by the software 230 that is selected based on information that was submitted about the candidate such as their particular field of expertise. The latter is particularly useful when recruiters in a given field of expertise have indicated that addressing certain skills or attributes is important for their evaluation.

In one embodiment, recruiters from a particular company may include or request additional questions be answered in response from a candidate that has been flagged as a potential hire. In such instance, the software 230 may further include scripts or questions that are specific to a company or recruiter and must be submitted by a candidate prior to complete evaluation. These videos could be created using a computer video camera, done in a professional studio or other means of video capture such as a digital camera or smartphone. Furthermore, while the video may be posted or created in a single sitting, it could also be posted or created in smaller recordings and, if desired, later concatenated by the video software 230.

As noted above, the video software 230 may also include one or more script(s) or question(s) generation routines that can provide a candidate with an outline of the areas that should be addressed or questions that they may wish to answer. For example, if the candidate were to have self-reported a high skill value in leadership, the video software could prompt the candidate to “Describe your leadership skills” when creating the video or could also present a “prepared script” for the candidate to use during video creation that highlights leadership as an area that they should address. This could optionally also be accompanied by recommendation on how long the segment should be or other coaching directions that can help improve the quality and impact of the video. The video software 230 also includes video compression algorithms and other tools for optimizing video playback and storage. The video generated and processed by the video software 230 is then stored in the candidate profile database 210 for further analysis and playback.

The video analytics software 235 includes tools for analyzing candidate videos to help extract, analyze and assess the video. The analytics software 235 is in communication with the video software 230 and receives the processed video. The analytics software includes tools for extracting the audio track and, applying one or more speech recognition algorithms (such as those offered by Nuance Communications), extract the words said by the candidate in the video. The purpose is two-fold. First, to use the extracted words to conduct a comparison between the skills and attributes linked to the candidate in the candidate profile database 210 with the words used during the video. This comparison may reveal that one or more key skills were not addressed and such comparison may trigger a follow-up request to the candidate or other communication indicating that the video profile may be incomplete. Similarly, the system could also work in reverse—if a skill is discussed in the video that is not listed on the candidate's profile in the candidate profile database 210, the analytics software 235, via the communications engine 250, could prompt the candidate to add that skill or expertise in their profile. The second function served by extracting the words is for the video analytics software 235 to use references to certain skills or keywords to create one or more “playback” points based on the presence of those key words. These key words may be based on skills or references to former employers (i.e. “When I was at Boeing . . . ”) or could also be based on location of the questions, scripts or other information provided by the video software 230 when the candidate in the video speaks the script. For example, if the script had included a request to complete the statement “My most thrilling moment as a leader was ______”, the analytics software 235 could identify the location of that phrase and mark the video playback point as relevant to the leadership skill. Each of the locations identified in the video that corresponds to the script or to the candidate profile are stored in the candidate profile database 210 for subsequent retrieval.

More specifically, as will be further explained below, once a recruiter inputs or otherwise searches on one or more these key words using the recruiter front end interface 110, the system would search the “script” created by analyzing the video to identify the portions of the video that would be of greatest interest to the recruiter and would permit playback of those relevant portions of the video thereby significantly reducing time spent watching video that is either of less relevance or less critical. Given that there may be many potential candidates, by indexing the video and permitting playback in this manner, the present invention significantly reduces the time and effort needed to filter down to a smaller pool of candidates.

The video analytics software 235 would also optimally include use of available emotional sensing technology to interpret the voice and body language of the candidate in the video. For example, software 235 may include one or more algorithms (such as Layered Voice Technology offered by Nemesysco Ltd) that are current available to analyze the tone, level, frequency or other attributes of the candidate's voice in the video. Using these characteristics of the video, the analytics software 235 can provide information regarding characteristics of the candidate that would otherwise not be easily ascertained.

One such characteristic is truthfulness. The video analytics software 235, by applying algorithms developed by voice and video technology companies, can ascertain, with a high degree of probability, if a candidate is telling the truth when discussing their skills or attributes. It is also possible, with various degrees of accuracy, to determine the level of truth. For example, if a candidate has reported their Leadership Skill Level as 10 but one or more of the voice and/or video algorithms in the analytics software 235 determines that the voice and/or body language in the video exhibits characteristics associated with lying, that skill could be flagged as a concern or, in extreme cases, could suggest that there is a good probability that the candidate is exaggerating their skills and experiences or just simply lying.

As noted above, the video analytics software 235 may also include algorithms for interpreting physical movements that may undermine the predicted accuracy or hidden intentions of the speaker as recorded on the video. Common physical cues, such as eyes shifting to the side or shifting in the seat or other variants, can also be ascertained to assess whether the speaker is comfortable, honest and/or confident about their reported skills and attributes.

The analytics software 235 could then store any results from this analysis in the candidate profile database 210. This could be as simple as a flag (i.e. flagged as potential concern) or could include more robust data such as a confidence interval or probability curve associated with the “reliability” of the stated skills. This could also trigger one or more messages to the candidate identifying the concern and requesting further third party verification or requesting that the candidate submit a video with follow-up questions that can be processed by the analytics software 235 to determine if the same result is returned the second time.

In all cases, the information generated from the video analysis would be stored in the candidate profile database 210. The data reported by the analytics software 235 could later be provided in conjunction with the video when it is located during a search by a recruiter, could be used to filter that candidate's profile from recruiters until further verification is complete, could lower their rank in any future searches on the skills that were flagged for veracity or could lower the candidate's verification score for that skill or attribute. Finally, while this analysis is described as being performed exclusively by a single algorithm, for cases in which a candidate objects to the analysis or where the algorithm appears to suggests a strong probability of a mistruth, a second analysis could be performed by an alternative algorithm stored within the analytics software 235 or a human psychology expert may be engaged to confirm the findings manually.

The system further includes a communications engine 250 for enabling communications between the system and a candidate, a recruiter or, if applicable, communications between the candidate and recruiter including feedback regarding the candidate's profile, follow-up questions or clarifications, arranging interviews and other related communications.

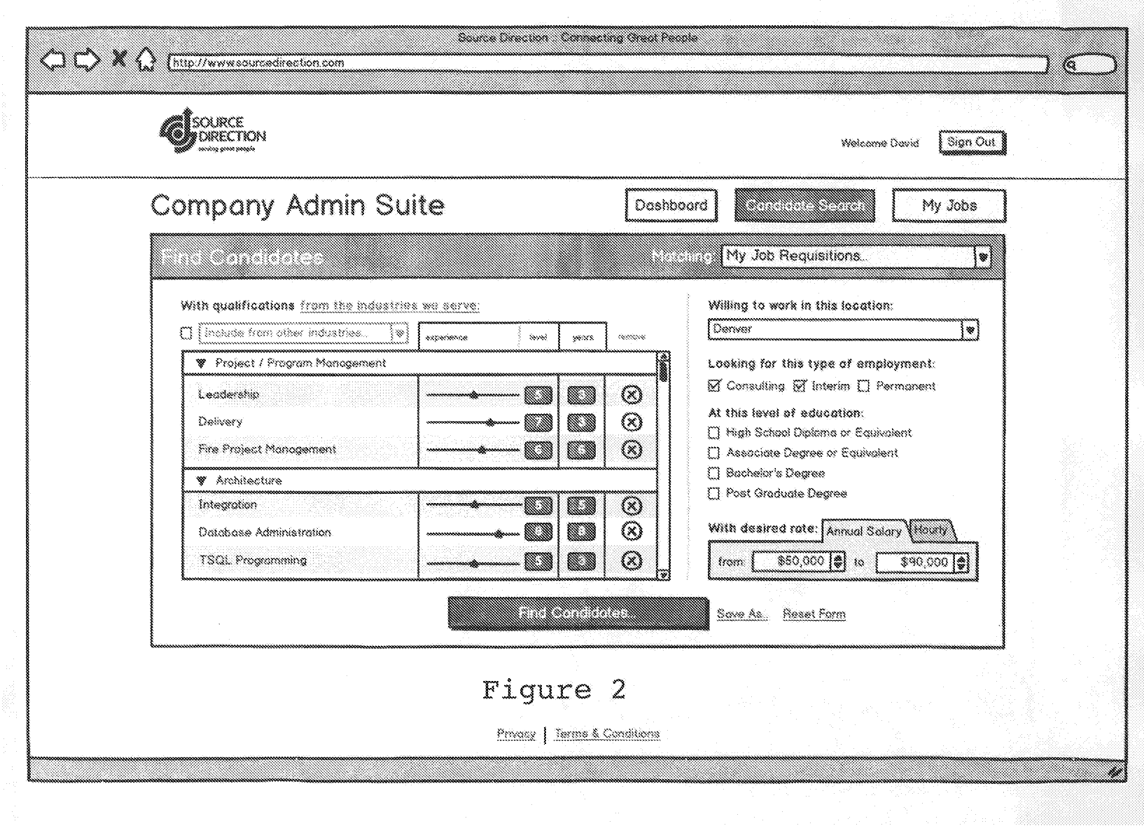

Logically connected to the communications engine 250 is the recruiter FEI 110. The recruiter FEI 110 includes pages for registering the recruiter including who the recruiter represents along with any company data that is stored in the recruiter/company database 210. This could further including uploading common profiles for jobs openings, job descriptions, company descriptions, and job requisitions. Once the recruiter is registered, the FEI 110 provides access to the search engine 215 that enables a search for one or more candidates using a list of desired skills, years of experience, and other attributes. As will be shown with reference to FIG. 2, the search engine 215 could use absolute requirements, a range of values, one or more skills can be added and then later removed, or any number of other choices that can help optimize locating a qualified candidate. Other features included in the recruiter FEI 110 includes video playback capabilities that permit recruiters to watch candidate videos (with in whole or based on the playback points created by the video software 230 based on skills or key words), to make notes or provide feedback to one or more candidates, to place a candidate profile into a list of possible hires, to compare one or more of the most promising candidates based on their candidate profiles and the applicable requirements as outlined in a job offer or requisition, and, if applicable, to initiate a request to schedule an interview with the candidate via the communications engine 250.

Referring now to FIG. 2, a sample embodiment of the search engine 215 as displayed to the recruiter via the recruiter FEI 110 is shown. As noted above with reference to FIG. 1, the search engine 215 can receive any number of criteria via the FEI 110 including work location, type of employment, level of education, skills desired, year of experience, salary and other factors. The recruiter could enter the search criteria into the FEI 110 manually or could match the search criteria to one or more requisition or job descriptions that have been provided and stored in the recruiter database 210.

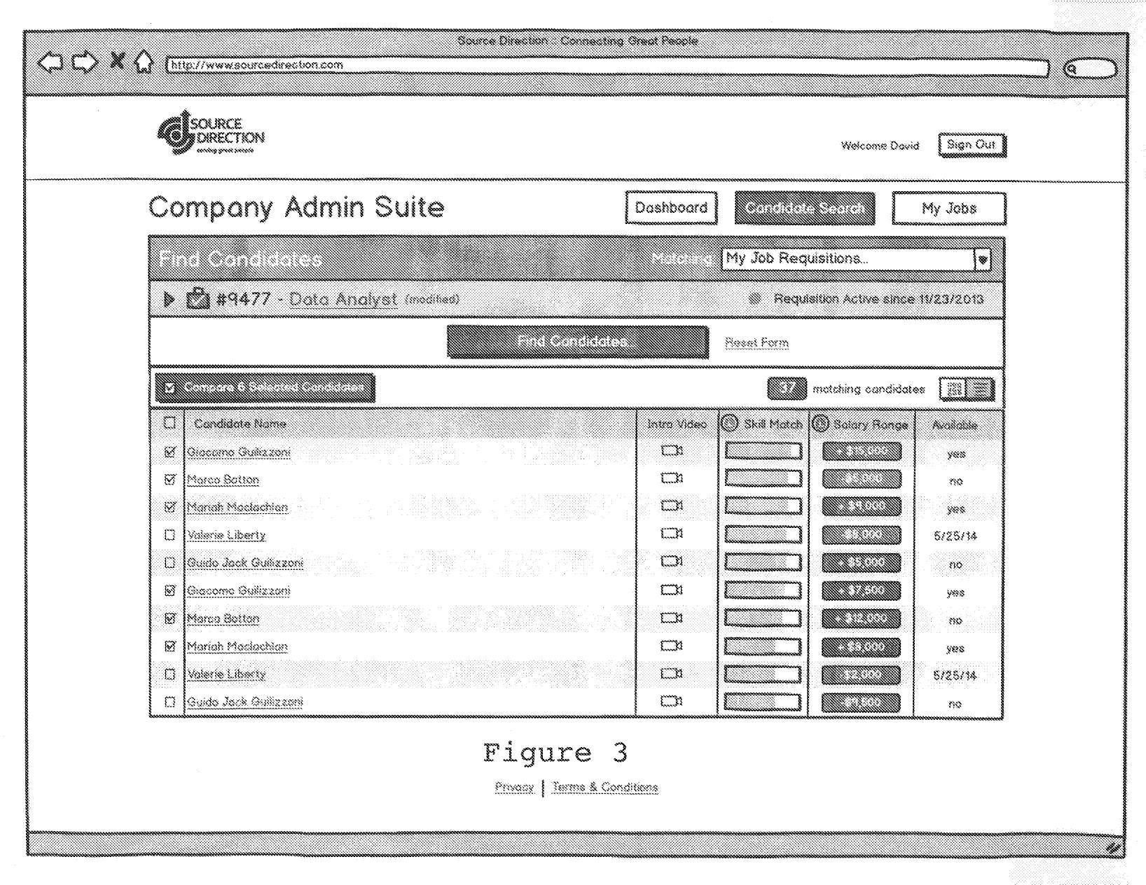

Referring now to FIG. 3, a sample embodiment illustrating the search results as presented via the FEI 110 are shown. In this illustration, candidate names, intro videos, salary, availability and “skill match” are shown on the page. This is intended to be a starting point of the search and is intended to simply provide a simple and easy to use interface. Each candidate name can be selected for further details or, as illustrated on the left side of FIG. 3, one or more candidates may be selected for side by side comparison.

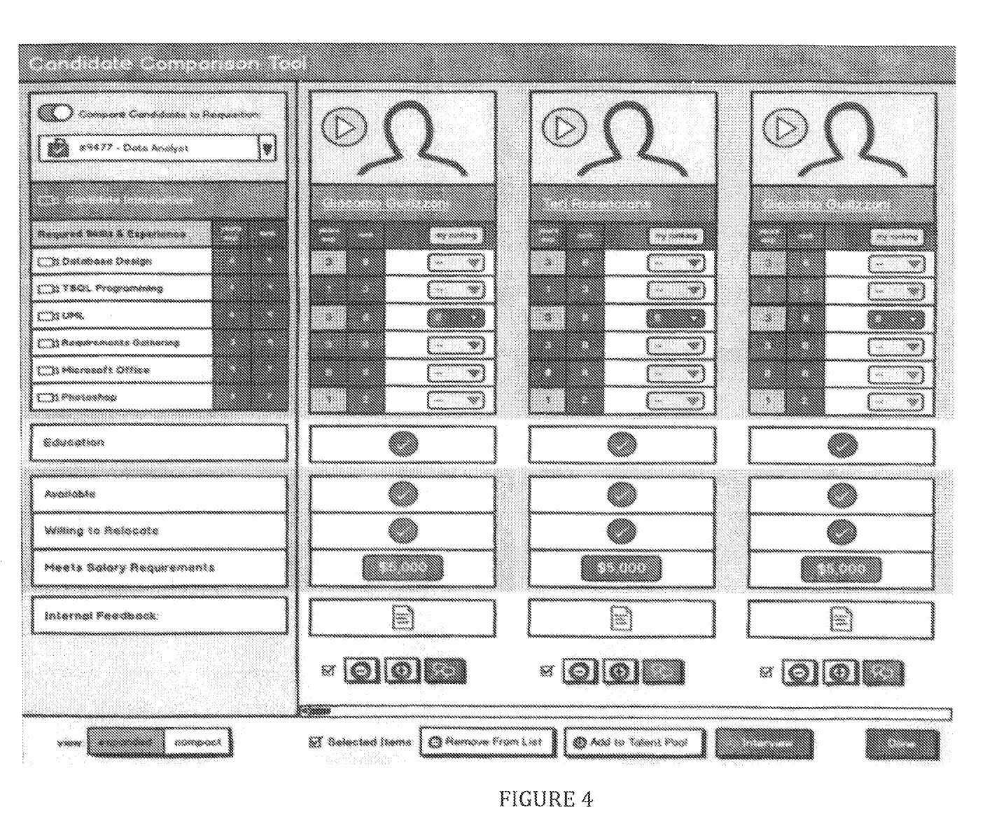

Referring now to FIG. 4, a sample embodiment of the FEI 110 pursuant to a candidate comparison request is shown. In this Figure, three different candidates are displayed although a slider bar on the bottom is provided in order to permit comparing as many candidates as desired. To the left of FIG. 4 is an outline of the skills and experience that are required for the job that the recruiter is trying to fill. Each of these requirements are then mapped across each candidate profile and, in this embodiment, are color-coded green, yellow and red to indicate whether they exceed, meet or fail to meet the criteria. This comparison tool makes it very easy to see to what extent a candidate meets or does not meet a given requirement. As noted above, the recruiter is also provided with an opportunity to provide feedback via the FEI 110 such as ranking the candidates, their respective skills, internal feedback, a candidate can be removed, a candidate can be added to a “talent pool” for further consideration, or can be selected for a follow-up interview. Furthermore, as illustrated at the top of each profile, video from each of the candidates are linked enabling simple video playback without leaving the feedback and comparison interface. Furthermore, if the recruiter were to select one of the required skills on the left of the page, the videos for each of the candidates would be updated to include only those video excerpts that relate to that skill or experience thus permitting a recruiter to hear and see each candidate discuss their experience with, for example, database design.

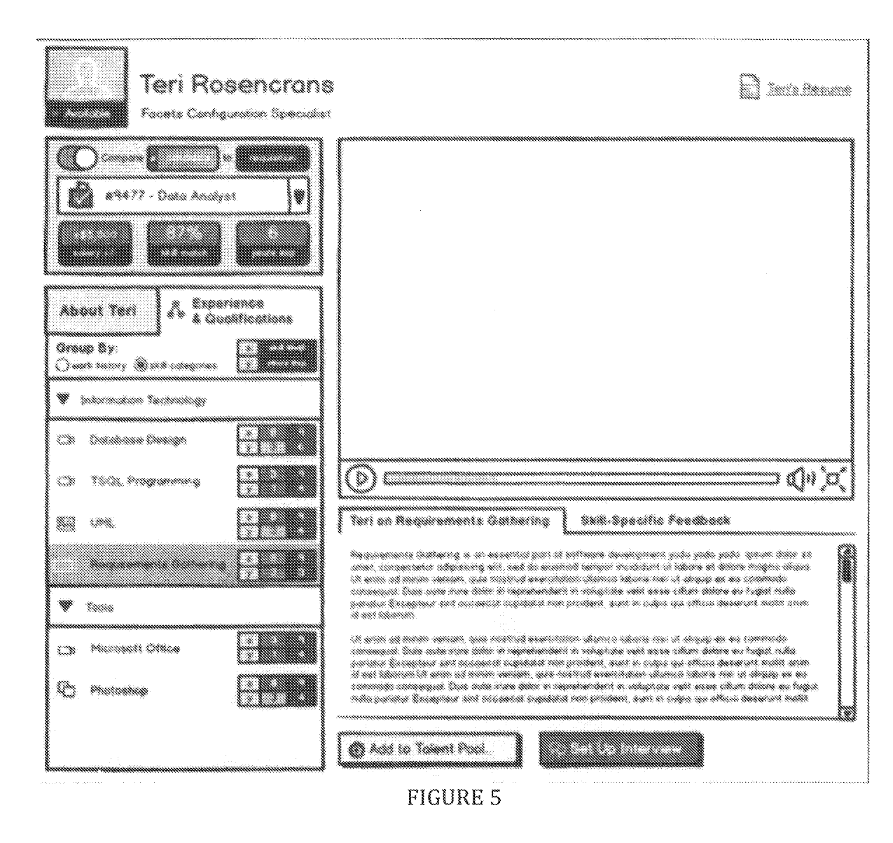

Referring now to FIG. 5, a sample embodiment of the FEI 110 illustrating a candidate profile is shown. As explained with reference to FIGS. 3 and 4, each results page—whether initial search results or tools such as comparisons, permit the selection of an individual candidate at any time. Responsive to that selection, a candidate profile such as the one shown in FIG. 5 would be presented. While illustrating some of the same information shown in the views provided in FIGS. 4 and 5, the candidate profile as shown on the FEI 110 provides much greater details about each skill, permits selection of each skill that provides a link to relevant video in which the candidate discussed that skill but also any notes or information that may have been provided by the candidate with respect to that skill or experience. The candidate profile is intended to both provide a good overview but, as shown in the illustration, a great deal of data is immediately visible and, with a single click, each skill can be examined in greater detail. As explained above, this “skills based” approach provides a much better perspective on the candidates fit, a much easier way to tell immediately if a candidate is a likely match and easy access to a single button to initiate an interview should the recruiter desire to do so.

In sum, the present invention provides a comprehensive method and system for registering candidates, retrieving a self-assessment of their own skills and experiences, validating one or more of their skills and experiences leveraging third party websites and/or former managers or colleagues, associating those skills with focused and relevant video clips that permits immediate assessment of honesty and interpersonal communication skills in key areas of need, simple comparisons between multiple candidates simultaneously without unnecessary clutter and a simple “one button” click to arrange an interview or provide feedback to a candidate. This approach not only provides a robust, easy to use and powerful approach but does it in a manner that makes it simple and time-efficient. For obvious reasons, the present invention provides light years of improvement over the current field of recruiting and hiring.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

I claim:

1) A software system for optimizing identification of candidates for a recruiter using a computer comprising:
a. A database for storing a list of common skills and information that may be submitted by a recruiter or candidate that interacts with the system;
b. Logically connected to the database, a front-end software interface that provides a visual means for a candidate to register by submitting personal information and identify relevant skills using a list of common skills and levels of experience with each skill;
c. Logically connected to the front-end interface, a connection software program for connecting one or more social websites that can be used to extract or validate information about the candidate's personal information and skills as entered by the candidate via the front end interface,
d. Logically connected to the front end interface, a video creation software program for creating or uploading one or more videos recorded by the candidate in response to one or more questions or scripts that is transmitted by the video creation software to the candidate using the front end interface,
e. Logically connected to the front-end interface, a software search engine for permitting recruiters to search for relevant characteristics of a candidate that is registered in the database.

2) The system of claim 1, further comprising a video analytics software program that is logically connected to the video creation software program that analyzes one or more features of a video transmitted by the candidate to ascertain one or more attributes about the candidate or their skills.

3) The system of claim 2, wherein the video analytics software program includes functions for analyzing the probable truthfulness of the candidate.

4) The system of claim 1, further comprising a video extraction software program that is logically connected to the video creation software that stores key words used in the video in the database associated with the candidate as provided by the script stored in the database.

5) The system of claim 4, wherein the software search engine is configured to retrieve one or more candidate profiles that include a video having at least one of the key words extracted by the video extraction software program.

6) The system of claim 5, wherein the information presented to the recruiter as a result of submission of a search request includes presentation of at least a portion of a candidate video that may correspond to the words words used in their search.

7) The system of claim 1, further comprising a communications engine for enabling communications and feedback between a recruiter and the candidate.

8) The system of claim 1, wherein the front-end software interface further includes a comparison software tool for permitting a recruiter to view one or more candidate profiles side by side.

9) The system of claim 1, wherein the software search engine further includes sliders that can be used to filter the results of the search to a single value or range of values that may be stored in a candidate profile.

10) A computer-implemented method for identifying candidates for open job positions being filled by a recruiter, comprising executing on a processor that is connected to the Internet the steps of:
a. transmitting a front-end interface for registration in response to a request to register as a candidate from a electronic device in communications with the computer;
b. storing electronic information received from a candidate including personal information and relevant skills using a list of common skills and an indicator of the levels of experience with each skill and storing the information in a profile in memory in the form of a profile;
c. transmitting video capture software and one or more scripts to the candidate that capture video information of the candidate answering the questions set forth on the script;
d. storing the video information in memory in association with the stored candidate profile;
e. identifying the location of any key words located in the audio track of the stored video file and storing the location of such key words in memory;
f. splitting the uploaded video file into one or more smaller video files using the stored locations of one or more keywords in memory as beginning and end points of such smaller video files; and
g. Storing smaller video files in memory in association with the candidate profile.

11) The method of claim 10, further comprising the steps of:
a. Transmitting a front-end interface that provides one or more search tools in response to a search request from a electronic device in communications with the computer; and
b. in response to receipt of an electronic search request, transmitting electronically one or more candidate profiles that are stored in memory that include at least one term included in such search request.

12) The method of claim 11, further comprising the step of transmitting any video files associated with the candidate profile that include the search term for playback by the requesting party.

13) The method of claim 10, further comprising the step of identifying one or more behaviors in the video track of the video file that are indicative of dishonesty and flagging the associated candidate profile for review.

14) The method of claim 11, wherein the transmission of a front end interface that provides one or more search tools further includes the step of transmitting one or more software-implemented sliders that can be used to further filter the search results.

15) The method of claim 11, wherein the step of transmitting electronically one or more candidate profiles that are stored in memory that include at least one term included in such search request includes the step of displaying multiple candidate profiles in a side by side view to permit easier comparisons.

16) The method of claim 11, further comprising the step of receiving information from the searching party regarding a profile and communicating such information to the candidate associated with such profile.

17) The method of claim 16, wherein the step of receiving information from the searching party includes receiving and subsequently communicating a request to arrange an interview the candidate associated with the profile.
